(19) United States
(12) Patent Application Publication
(10) Pub. No.: US 2009/0217545 A1
(43) Pub. Date: Sep. 3, 2009

(54) Laundry appliance front control panel assembly

(75) Inventors: Nedo Banicevic, Hamilton (CA); Fan Wu, Burlington (CA)

Correspondence Address: CRAIG WILSON, 2570 MATHESON BLVD. EAST, SUITE 211, MISSISSAUGA, ON, L4W 4Z3, CA

(73) Assignee: MABE CANADA INC., Burlington (CA)

(21) Appl. No.: 12/314,042

(22) Filed: Dec. 3, 2008

(30) Foreign Application Priority Data
Feb. 29, 2008 (CA) 2,623,649

(51) Int. Cl. F26B 19/00; A47B 96/00

(52) U.S. Cl. 34/89; 312/228; 312/234

(57) ABSTRACT

A front control panel assembly is mounted to an upper portion of a laundry appliance cabinet. The control panel has upper and lower spaced apart support brackets, each having a slot having a guiding portion and a trough. A heat shield is mounted to the cabinet and has four spaced apart cantilever posts each having a shaft portion and an end portion received in the support brackets to support the control panel to the cabinet. The lower support brackets secure the corresponding shaft portion via a clasp portion. The secured control panel can move only in opposite first and second radial directions relative the axis of the shaft portion. The guiding portion helps locate the cantilever posts relative the support brackets. A screw passing frontally through the control panel secures it to the heat shield. Cantilever post support bracket cooperation inhibits control panel rotation about the axis of the screw.

### FIELD OF THE INVENTION

The present invention relates to a laundry appliance, such as a clothes dryer or clothes washer having a front control panel assembly for use with a vertically extending front panel and, in particular it relates to the assembly of the control panel to the laundry appliance.

### BACKGROUND OF THE INVENTION

Laundry appliance front control panel assemblies typically comprise a control panel which has dials or buttons manipulated by the user to direct the operation of the clothes dryer or washer. Posterior to the control panel is a heat shield to which the control panel may be mounted. Located therebetween is a circuit board or electronic board configured to respond to input from the control panel. The front control panel assembly is mounted to an upper portion of the main cabinet of the appliance.

In the past, laundry appliances typically comprised a vertically extending front panel. The control panel is typically secured to the heat shield via a screw received by the control panel from the rear. Other embodiments include screws which pass through the control panel from the front to be received by a support panel or member. Prior to the attachment of the screw, the control panel must be held in place. This is often done manually, which can create difficulty for an assembler trying to secure the panel with a screw.

### BRIEF DESCRIPTION OF THE INVENTION

The present invention relates to a laundry appliance having a main cabinet, a support panel secured to an upper portion of the main cabinet and a control panel coupled with the cabinet via the support panel.

In accordance with one embodiment of the present invention there is provided a control panel coupled with the main cabinet of the laundry appliance via the support panel. The support panel is secured to an upper portion of the main cabinet. One of the support panel and the control panel has at least two spaced apart cantilever posts each comprising a shaft portion having a first diameter and an axis and an end portion having a second diameter greater than the first diameter. The other one of the support panel and the control panel has at least two spaced apart support brackets depending therefrom. Each of the support brackets receives the end portion of a corresponding one of the cantilever posts in a first radial direction to prevent axial movement of the support bracket along the axis of the corresponding cantilever post. Each support bracket also permits radial movement of the bracket relative to the cantilever post and a second radial direction opposite to the first radial direction.

By providing at least two spaced apart corresponding cantilever posts and support brackets in co-operation with each other, the control panel can be readily positioned relative to the support panel. Positioning the end portion of each cantilever post within a support bracket prevents the panel from moving forward and backward relative to the support panel.

In accordance with another embodiment of the present invention, the support panel is a heat shield which has a main body and has at least two spaced apart cantilever posts. Each cantilever post may comprise a wheel and a shoulder screw passing therethrough for attachment to the heat shield. The shoulder screw has a first diameter and the wheel has a second diameter greater than the first diameter. In an alternative embodiment, each cantilever post may comprise a shoulder screw having a threaded shaft portion and an end portion. The threaded shaft portion comprises a first diameter and the end portion comprises a second diameter greater than the first diameter. The control panel has at least two spaced apart support brackets comprising a wall surface portion having a slot comprising a width that is less than the first diameter of the wheel. Each of the slots receives the shoulder screw of a corresponding one of the cantilever posts with the surface portion of the slot sandwiched between the heat shield main body and the wheel whereby the cantilever post and support bracket co-operate to prevent axial movement of the support bracket along the axis of the corresponding cantilever post and permit radial movement of the bracket relative to the cantilever post in a first radial direction and a second radial direction opposite the first radial direction.

In accordance with another embodiment of the present invention, each support bracket may comprise a slot having an opening, a trough and a clasp portion for capturing the cantilever post shaft portion. The clasp portion is characterized by two protuberances, with one at each junction of the trough and the guiding portion. The opening of the clasp portion has a distance thereacross slightly less than the first diameter of the shaft portion of the cantilever post. The trough has a diameter the same as the first diameter of the shaft portion of the cantilever post. The clasp portion and the trough provide a means of locking into place the shaft portions of the cantilever posts. This facilitates a more secure engagement between the control panel and the support panel.

In accordance with yet another embodiment of the present invention, each support bracket comprises a wall surface portion comprising a slot and is configured to guide into place the shaft portion of the cantilever post by means of a guiding portion having two symmetrically disposed convergent wall portions extending lateral to the slot. The guiding portion of the slot facilitates easier alignment of the support brackets with the cantilever posts. This permits easier assembly of the control panel assembly.

In a further embodiment, the control panel is positively fastened to the support panel by a screw which passes through a recessed opening in the control panel and is received by the support panel. The screw and recessed opening are covered by a removable appliance control knob. Front access to the screw renders assembly and disassembly of the control panel assembly much more convenient. The recessed opening provides easy access to the screw, but the control knob gives an aesthetically pleasing look to the appliance when the clothes dryer or washer is in normal use.

In another embodiment, the control panel may further comprise rearwardly depending peripheral wall portions each having rear peripheral edges for at least partially supporting the support brackets adjacent thereto.

In another embodiment of the present invention, the heat shield has four cantilever posts, the control panel has four corresponding spaced apart support brackets comprising two upper support brackets and two lower support brackets.

In yet another embodiment of the invention, each support bracket is at least partially supported by the rear peripheral edge adjacent thereto. The upper support brackets further comprise a clasp portion and a side wall opposite the rear peripheral edge and the lower support brackets further comprise a socketed wall portion depending from the wall surface portion. The socketed wall portion comprises a receiving pocket with a third diameter slightly greater than the second diameter of the wheel.

In one embodiment of the present invention, the control panel may comprise at least one locating foot. The locating foot depends from at least one rearwardly depending flange. The laundry appliance comprises a front panel and the front panel comprises a top surface portion comprising at least one foot receiving hole for receiving the at least one locating foot therein. Each of the at least one foot receiving holes receives a corresponding one of the at least one locating feet in the first radial direction.

It should be understood that in other embodiments the end portion of the cantilever post may comprise a bulbous prominence or an inturned flange. The end portion of the cantilever post may comprise galvanized steel or plastic. The control panel may comprise plastic and the heat shield may comprise galvanized steel. Further, both the end portion of the cantilever post and the control panel may comprise plastic in order to improve the ability with which the two surfaces can slide past one another. The plastics may comprise, in one embodiment, a hard plastic such as nylon.

### BRIEF DESCRIPTION OF THE DRAWINGS

For a more thorough understanding of the nature and objects of the present invention reference may be had, by way of example, to the accompanying diagrammatic drawings in which:

FIG. 1 is an image of an exemplary laundry appliance that may benefit from the present invention showing the control panel unassembled.

FIG. 2 is a front view of an exemplary laundry appliance that may benefit from the present invention.

FIG. 3 is a front view of the control panel of the laundry appliance.

FIG. 4 is a cross-sectional side view of the control panel of the laundry appliance with the cross-section taken along line A-A of FIG. 3.

FIG. 5 is a cross-sectional side view of the control panel of the laundry appliance with the cross-section taken along line B-B of FIG. 3.

FIG. 5a is a top view cross-sectional perspective of one embodiment of the engagement between a cantilever post and a support bracket.

FIG. 5b is a second top view cross-sectional perspective of an alternative embodiment of the engagement between a cantilever post and a support bracket.

FIG. 6 is a perspective rear view of the control panel.

FIG. 6a is an enlarged perspective view of a support bracket.

FIG. 7 is a perspective view of the control panel with the circuit board coupled thereto.

FIG. 8 is an isometric front view of the support panel with an exploded view of the cantilever posts.

FIG. 9 is an exploded isometric front view of the control panel assembly with the circuit board between the control panel and the heat shield.

### DETAILED DESCRIPTION OF THE INVENTION

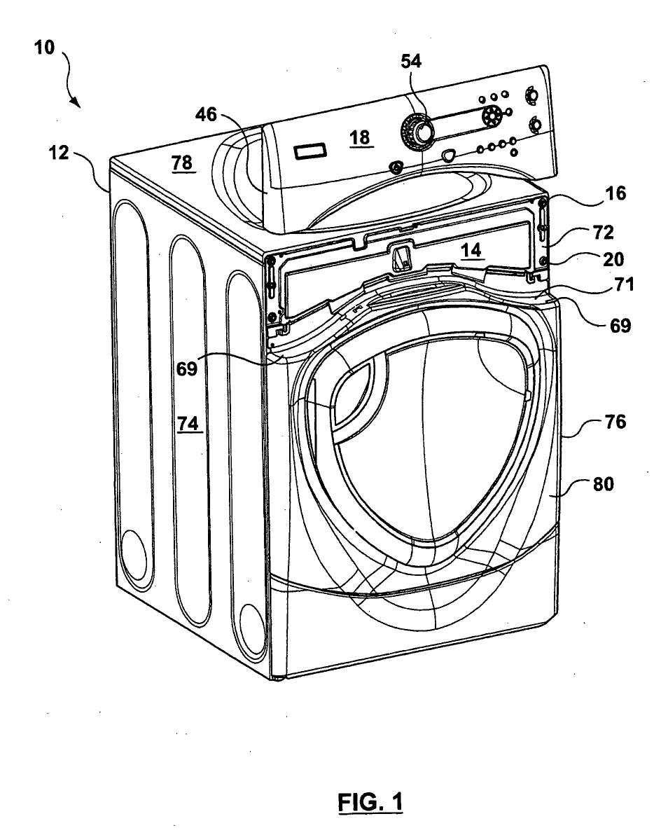

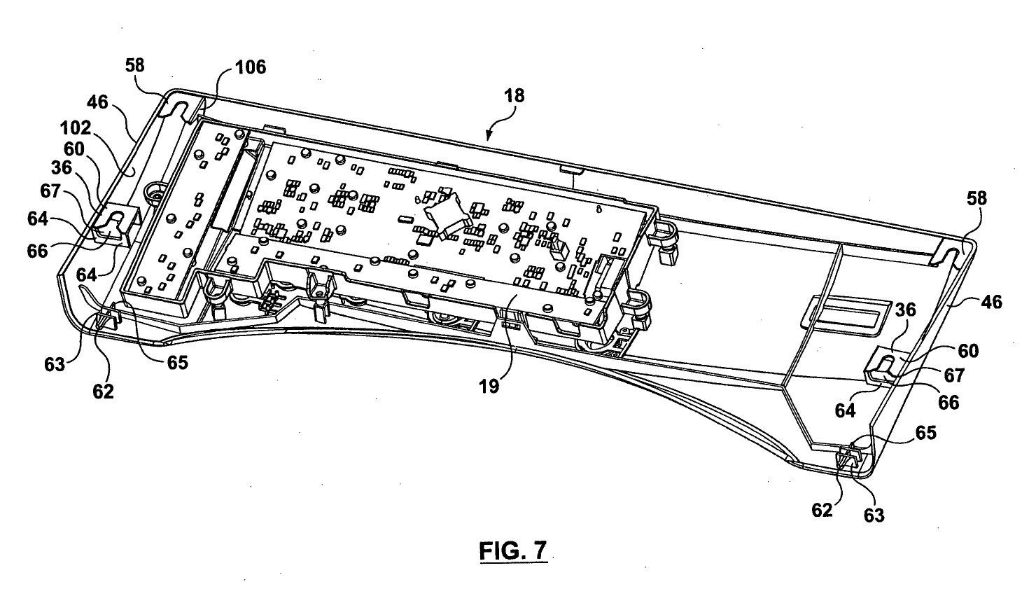

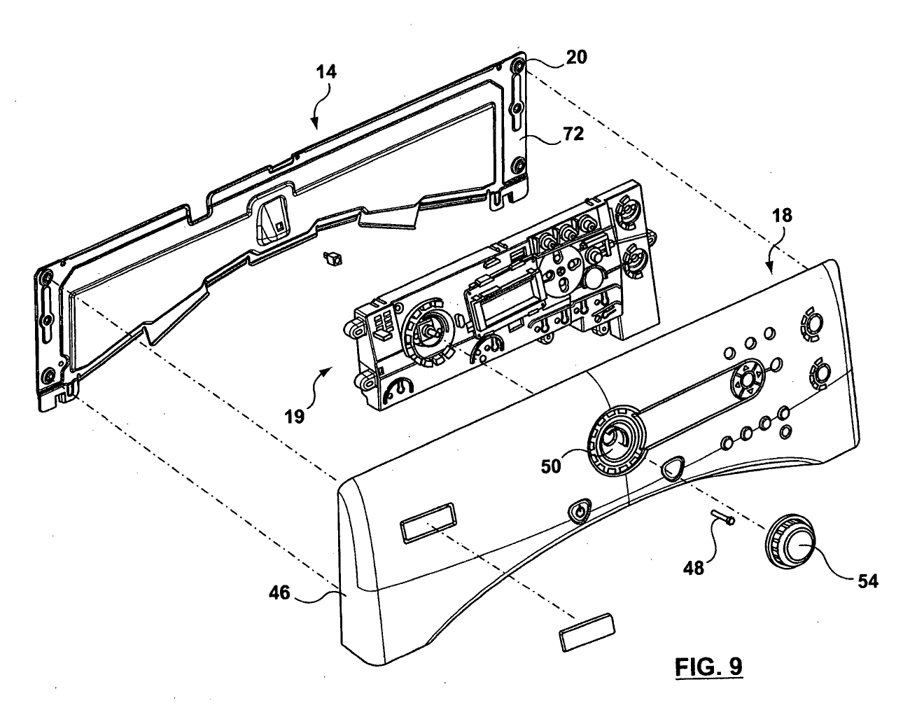

Referring to FIGS. 1, 2 and 5 there is shown an exemplary laundry appliance 10 comprising a main cabinet 12, a support panel 14 secured to an upper portion of the main cabinet 12, and a control panel 18 coupled with the main cabinet 12 via the support panel 14. In this embodiment, the support panel 14 comprises a heat shield made of galvanized steel to prevent excessive heat from escaping the main cabinet 12 and damaging the plastic control panel 18. The main cabinet 12 comprises side panels 74 and 76, front panel 80 and top panel 78. The front panel 80 further comprises a top surface portion 71. There may be a circuit board 19 (FIGS. 7 and 9) between the support panel 14 and the control panel 18. The circuit board 19 is coupled with the control panel 18 and responds to the commands inputted by a user via the control panel 18.

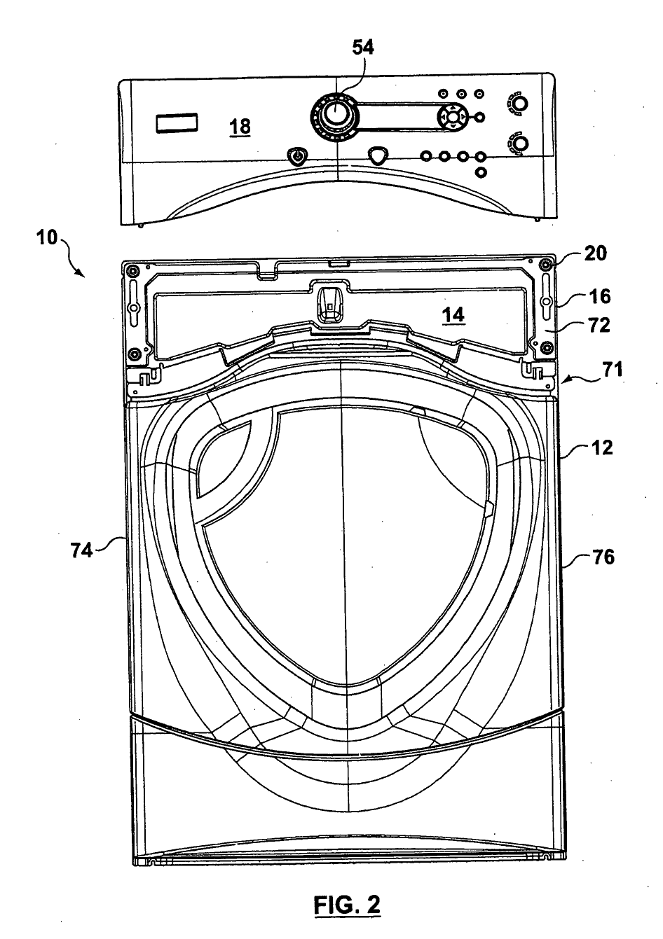

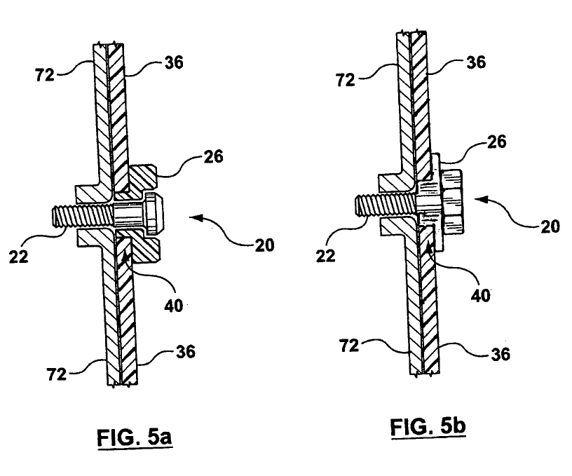

In FIG. 2, the heat shield 14 is shown to have a main body 72. Four spaced apart cantilever posts 20 extend from the heat shield 14 and comprise an end portion 26 and a shaft portion 22. The four spaced apart cantilever posts 20 are mounted to each corner of the heat shield 14. The shaft portion 22 of the cantilever posts 20 comprises a shoulder screw made of galvanized steel having a first diameter and an axis 24. The end portion 26 of the cantilever posts 20 comprises a wheel made of nylon having a second diameter greater than the first diameter of the shoulder screw 22. The shoulder screw 22 passes through the wheel 26 to be threadably received by the heat shield 14 (FIG. 5a). As shown in FIGS. 5a and 5b, the cantilever post 20 may comprise a plurality of component parts or a singular component part. FIG. 5a shows that the cantilever post 20 consists of a shoulder screw 22 passing through an end portion or wheel 26 to be received by the heat shield main body 72. Alternatively, in FIG. 5b, it is shown that the entire cantilever post consists of a singular component. In FIG. 5b, the wheel like end portion 26 of the cantilever post 20 is continuous of the shaft portion 22, the shaft portion 22 being received by the heat shield main body 72.

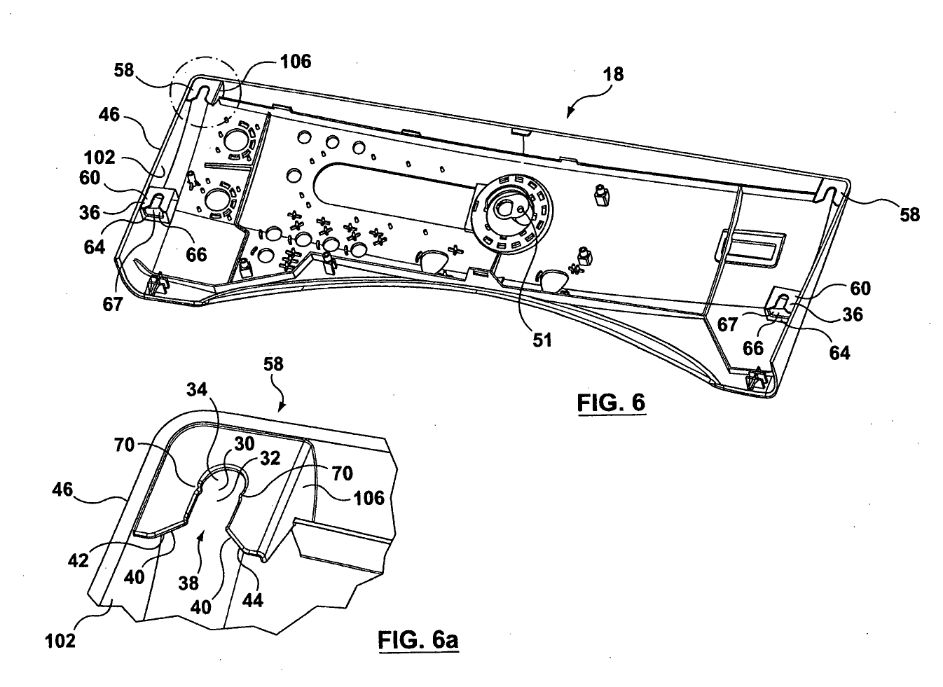

These cantilever posts 20 are engaged by corresponding support brackets 58, 60 (FIGS. 6 and 6a) from the control panel 18 to mount the control panel 18 securely to the heat shield 14. Referring to FIGS. 6 and 6a, the control panel 18 is shown to have four spaced apart support brackets 58, 60. Each support bracket 58, 60 comprises a wall surface portion 36 having a slot 38 comprising a width that is less than the second diameter of the wheel 26. Referring to FIG. 5, the engagement between the cantilever posts 20 and the support brackets 58, 60 is shown. Each of the slots 40 receives the shoulder screw 22 of a corresponding one of the cantilever posts 20 with the wall surface portion 36 sandwiched between the heat shield main body 72 and the wheel 26. The cantilever post 20 and support bracket 58, 60 cooperate to prevent axial movement of the support bracket 58, 60 along the axis 24 of the corresponding cantilever post 20 and permits radial movement of the support bracket 58, 60 relative to the cantilever post 20 in a first radial direction (vertically downward) and a second radial direction (vertically upward) opposite to the first radial direction due to the orientation of the slot opening 38 in the brackets 58, 60. This engagement permits the control panel 18 to be positioned relative to the heat shield 14. By positioning the end portions 26 of each cantilever posts 20 within the support brackets 58, 60, the control panel 18 is prevented from moving horizontally forward and backward relative to the heat shield 14.

Referring once again to FIGS. 6 and 6a, the control panel 18 further comprises a rearwardly depending peripheral wall portion 46 having a rear peripheral edge 102. The support brackets 58, 60 are at least partially supported by the rear peripheral edges 102. Each of the four support brackets 58, 60 comprises a guiding portion 40 and a wall surface portion 36 comprising a slot 38 having a trough 34. The guiding portion 40 is characterized by two symmetrically disposed convergent wall portions 42 and 44 lateral to the trough 34. The convergent wall portions 42, 44 facilitate guiding of the cantilever posts 20 into the slots 38. The four spaced apart support brackets 58, 60 further comprise two upper support brackets 58 and two lower support brackets 60. The lower support brackets 60 further comprise a socketed wall portion 64 depending from the wall surface portion 36. As shown in FIG. 7, the socketed wall portion 64 comprises a receiving pocket 66 having a third diameter 67 slightly greater than the first diameter of the wheel 26. The socketed wall portion 64 serves as a means of properly positioning the wheel 26 relative to the wall surface portion 36 during engagement of the cantilever post 20 by the support bracket 58, 60. The upper support brackets 58 further comprise a side wall 106 that is opposite the rear peripheral edge 102. The side wall 106 serves to better secure the wheel 26 into position while the cantilever post 20 co-operates with the upper support bracket 58. The slots 40 of the upper support brackets 58 further comprise a clasp portion 30 for capturing the shoulder screw 22 of the cantilever post 20. The clasp portion is characterized by two protuberances 70, one at each junction of the guiding portion 40 and the trough 34. The clasp portion 30 has a distance thereacross slightly less than the first diameter of the shoulder screw 22. The trough 34 has a diameter that is the same as the first diameter of the shoulder screw 22. The shaft portion 22 is embraced within the trough 34 by the clasp portion 30 when the cantilever posts 20 co-operate with the lower support brackets 60. The clasp portion 30 temporarily deflects to permit the cantilever posts 20 to be snapped into place within trough 34.

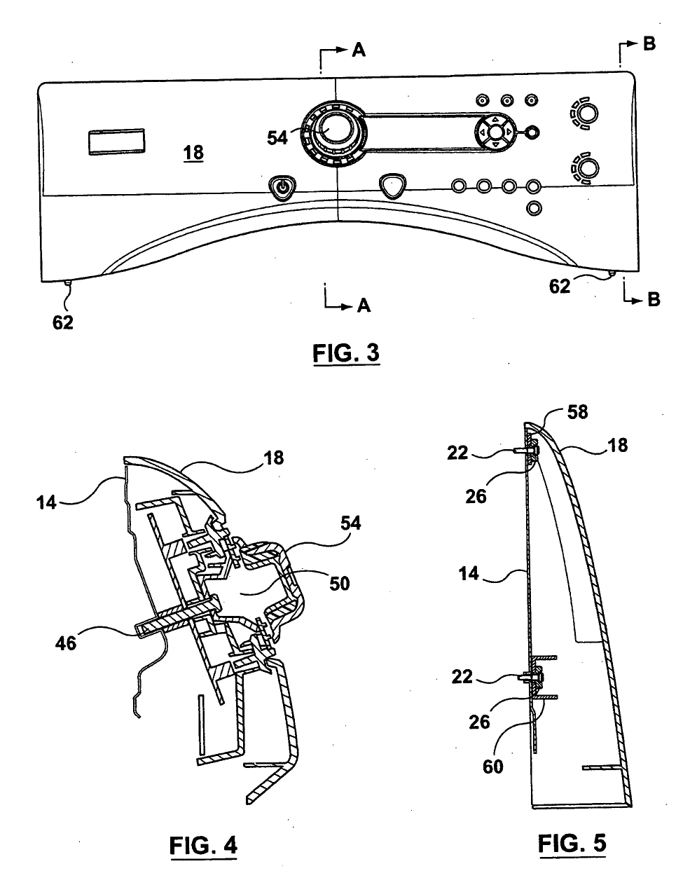

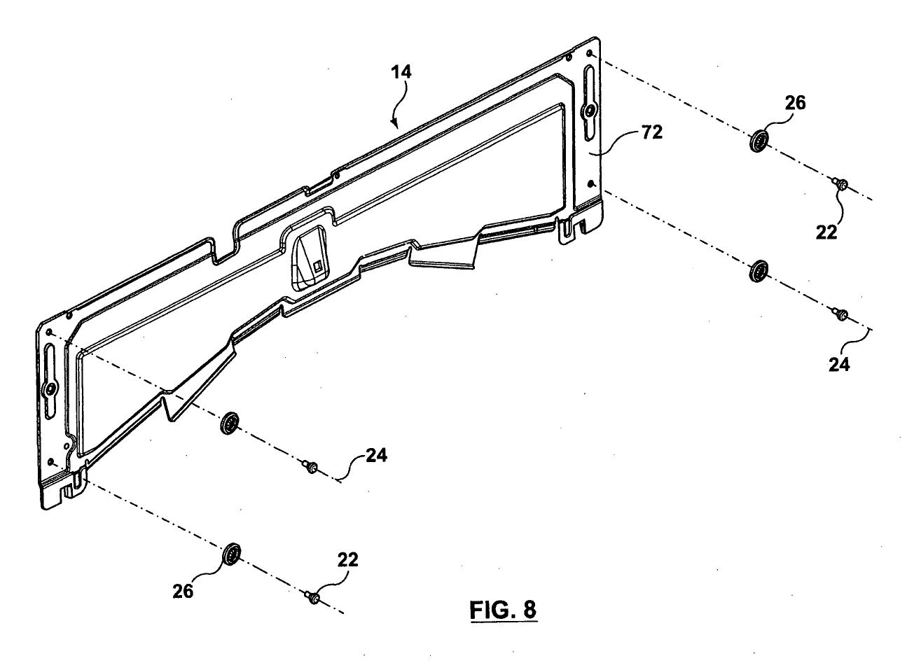

Referring to FIG. 8 the shoulder screws 22 align with the wheels 26 along an axis 24. Each shoulder screw 22 passes through the center of one of the wheels 26 and is threadably received by the heat shield 14. In FIGS. 3, 4, 7 and 9 there is shown that the control panel 18 is positively secured to the heat shield 14 via a screw 48 which passes through the control panel 18 via aperture 51 (FIGS. 4 and 6) in a recessed opening 50. The screw 48 is threadably received by the heat shield 14. The screw 48 and the recessed opening 50 are frontally accessible and are covered from view by a removable knob 54. Once fastened in place, the control panel 18 is inhibited from rotating about an axis created by the screw 48 due to the positioning of the cantilever posts 20 into the support brackets 58, 60.

In FIG. 7 (also shown in FIG. 3) there is shown a pair of spaced apart locating feet 62. In one embodiment, the locating feet 62 may comprise locating pegs. Each of the locating pegs 62 may depend from a rearwardly depending flange 63. In one embodiment, each of the locating pegs 62 may depend from a plurality, such as a pair, of flanges 63 that are each coupled with a support 65 extending between each flange 63 of the plurality of flanges 63, which provides additional support for the locating pegs 62. The locating pegs 62 serve to provide additional means for locating and securing the front panel 18 relative the heat shield 14. The locating feet 62 locate and align the front control panel 18 side to side and front to back, for positioning of the front control panel 18 relative to the heat shield 14. Accordingly, the front panel top surface portion 71 comprises foot receiving holes 69 corresponding to each of the locating feet 62. During installation of the front control panel assembly, each of the locating feet 62 are positioned relative the foot receiving holes 69, and with the location of the cantilever post end portions 26 into the receiving pockets 66, the locating feet 62 are accordingly located within the foot receiving holes 69. It should be understood that either a singular locating foot 62 or a plurality of locating feet 62 may be used with the present invention.

It should be understood that in alternative embodiments, the wheels 26 and the shoulder screws 22 may be comprised of galvanized steel. The end portion 26 may comprise a bulbous prominence or an inturned flange.

In yet another alternative embodiment, the cantilever posts 20 may be located on the control panel 18 and the support brackets 58, 60 may be located on the heat shield 14. It should be understood that alternative embodiments may comprise at least two corresponding pairs of cantilever posts 20 and support brackets 58, 60.

While the invention has been described in terms of various specific embodiments, those skilled in the art will recognize that the invention can be practiced with modifications within the scope of the present invention as disclosed herein.

What is claimed is:

1. A laundry appliance comprising:
a main cabinet;
a support panel secured to an upper portion of said main cabinet;
a control panel coupled with said main cabinet via said support panel;
wherein:
one of the support panel and the control panel comprises at least two spaced apart cantilever posts each comprising a shaft portion comprising a first diameter and an axis, and an end portion comprising a second diameter greater than the first diameter; and,
the other one of the support panel and the control panel comprising at least two spaced apart support brackets depending therefrom; and,
each of the support brackets receives the end portion of a corresponding one of the cantilever posts in a first radial direction to prevent axial movement of the support bracket along the axis of the corresponding cantilever post and permits radial movement of the support bracket relative to the cantilever post in a second radial direction opposite to the first radial direction.

2. A laundry appliance as in claim 1 wherein:
each of the support brackets comprises a slot comprising a trough and a clasp portion for capturing the cantilever post shaft portion wherein an opening of said clasp portion comprises a distance thereacross slightly less than the first diameter of the shaft portion of the cantilever post, the clasp portion temporarily deflecting to permit the capturing of the shaft portion within the trough.

3. A laundry appliance as in claim 2 wherein:
the trough comprises a diameter approximately the same as the first diameter of the shaft portion of the cantilever post.

4. A laundry appliance as in claim 1 wherein:
each of the support brackets comprises a wall surface portion comprising a slot, and is configured to guide into place the shaft portion of the cantilever post by means of a guiding portion having two symmetrically disposed convergent wall portions extending lateral to the slot.

5. A laundry appliance as in claim 2 wherein:
each of the support brackets comprises a wall surface portion comprising the slot, and is configured to guide into place the shaft portion of the cantilever post by means of a guiding portion having two symmetrically disposed convergent wall portions extending lateral to the slot.

6. A laundry appliance as in claim 2 wherein:
the control panel further comprises rearwardly depending peripheral wall portions, the peripheral wall portions having a rear peripheral edge for at least partially supporting the support brackets adjacent thereto.

7. A laundry appliance as in claim 1 wherein:
the control panel is fixedly secured to the support panel by a screw which passes through the control panel via a recessed opening in the control panel, and is received by the support panel.

8. A laundry appliance as in claim 2 wherein:
the control panel is fixedly secured to the support panel by a screw which passes through the control panel via a recessed opening in the control panel, and is received by the support panel.

9. A laundry appliance as in claim 1 wherein:
the end portion of each cantilever post comprises a bulbous prominence.

10. A laundry appliance as in claim 1 wherein:
the end portion of each cantilever post comprises an inturned flange.

11. A laundry appliance as in any one of claim 1 wherein:
the support panel is a heat shield.

12. A laundry appliance as in claim 1 wherein:
the control panel comprises at least one locating foot, the locating foot depending from at least one rearwardly depending flange,
the laundry appliance further comprises a front panel, the front panel comprises a top surface portion comprising at least one foot receiving hole for receiving the at least one locating foot therein,
each of the at least one foot receiving holes receiving a corresponding one of the at least one locating feet in the first radial direction.

13. A laundry appliance as in claim 6 wherein:
each of the support brackets is at least partially supported by the rear peripheral edge, the support brackets comprising lower support brackets further comprising a socketed wall portion depending from the wall surface portion, the socketed wall portion comprising a receiving pocket comprising a third diameter slightly greater than the second diameter of the end portion of the corresponding cantilever post, the end portion comprising a wheel for insertion into the receiving pocket.

14. A laundry appliance as in claim 7 wherein:
the recessed opening and screw are covered from view by a removable knob.

15. A laundry appliance comprising:
a main cabinet;
a heat shield fastened to an upper portion of the main cabinet, the heat shield comprising a main body and at least two spaced apart cantilever posts each comprising a shaft portion and an end portion the shaft portion comprising a first diameter, and the end portion comprising a second diameter greater than the first diameter; and,
a control panel coupled with the main cabinet through a mounted engagement with the heat shield, the control panel comprising at least two spaced apart support brackets, each support bracket comprising a wall surface portion having a slot comprising a width that is less than the first diameter of the end portion, each of the slots receiving the shaft portion of a corresponding one of the cantilever posts with the wall surface portion sandwiched between the heat shield main body and the end portion whereby the cantilever post and support bracket co-operate to prevent axial movement of the support bracket along the axis of the corresponding cantilever post and to permit radial movement of the support bracket relative to the cantilever post in the first radial direction and a second radial direction opposite to the first radial direction.

16. A laundry appliance as in claim 15 wherein:
the slots of the support brackets comprise a guiding portion and a trough, the guiding portion characterized by two symmetrically disposed convergent wall portions extending lateral to the trough.

17. A laundry appliance as in claim 15 wherein:
the control panel is fixedly secured to the heat shield via a screw which passes through the control panel via a recessed opening in the control panel and is received by the heat shield.

18. A laundry appliance as in claim 15 wherein:
the control panel further comprises peripheral wall portions comprising a rear peripheral edge for at least partially supporting each of the support brackets adjacent thereto.

19. A laundry appliance as in claim 15 wherein:
the heat shield is comprised of galvanized steel and the control panel is comprised of plastic.

20. A laundry appliance as in claim 15 wherein:
the end portion and the shaft portion are comprised of galvanized steel.

21. A laundry appliance as in claim 15 wherein:
the end portion is comprised of nylon and the shaft portion is comprised of galvanized steel.

22. A laundry appliance as in claim 17 wherein:
the screw and recessed opening are frontally accessible and are covered from view by a removable knob.

23. A laundry appliance as in claim 15 wherein:
the heat shield comprises four spaced apart cantilever posts, the control panel comprises four spaced apart support brackets corresponding to the cantilever posts, the support brackets comprising two laterally spaced apart upper support brackets and two laterally spaced apart lower support brackets, each support bracket is at least partially supported by the rear peripheral edge to support the control panel relative the heat shield.

24. A laundry appliance as in claim 23 wherein:
each support bracket comprises a wall surface portion comprising the slot and is at least partially supported by the rear peripheral edge, the upper support brackets further comprising a side wall opposite the rear peripheral edge, the lower support brackets further comprising a socketed wall portion depending from the wall surface portion, the socketed wall portion comprising a receiving pocket with a third diameter slightly greater than the second diameter of the end portion.

25. A laundry appliance as in claim 23 wherein:
the slots of the upper support brackets further comprise a trough, and a clasp portion for capturing the shaft portion wherein an opening of said clasp portion has a distance thereacross slightly less than the first diameter of the shaft portion, the clasp portion temporarily deflecting to capture the shaft portion within the trough.

26. A laundry appliance as in claim 24 wherein:
the slots of the upper support brackets further comprise a trough, and a clasp portion for capturing the shaft portion wherein an opening of said clasp portion has a distance thereacross slightly less than the first diameter of the shaft portion, the clasp portion temporarily deflecting to capture the shaft portion within the trough.

27. A laundry appliance as in claim 15 wherein:
the control panel comprises at least one locating foot, the locating foot depending from at least one rearwardly depending flange,
the laundry appliance further comprises a front panel, the front panel comprises a top surface portion comprising at least one foot receiving hole for receiving the at least one locating foot therein,
each of the at least one foot receiving holes receiving a corresponding one of the at least one locating feet in the first radial direction.
